(19) United States
(12) Patent Application Publication
(10) Pub. No.: US 2004/0055845 A1
(43) Pub. Date: Mar. 25, 2004

(54) Housing arrangement for a friction clutch

(75) Inventors: Horst Friedrich, Aidhausen (DE); Arnold Huisjes, Schweinfurt (DE); Elmar Unsleber, Poppenhausen (DE); Jorg Pankoke, Leonberg (DE)

Correspondence Address: COHEN, PONTANI, LIEBERMAN & PAVANE, 551 FIFTH AVENUE, SUITE 1210, NEW YORK, NY, 10176, US

(73) Assignee: Sachs Race Engineering GmbH

(21) Appl. No.: 10/644,230

(22) Filed: Aug. 20, 2003

(30) Foreign Application Priority Data
Aug. 28, 2002 (DE) 102 39 419.9

(51) Int. Cl. F16D 13/60

(52) U.S. Cl. 192/70.2; 192/112

(57) ABSTRACT

A housing arrangement for a friction clutch including a ring-like housing wall region which has on its radially inward-facing inside a toothing formation for the rotary coupling of at least one friction member, the housing arrangement further including an annular disk-shaped housing bottom region integral with the housing wall region.

### BACKGROUND OF THE INVENTION

1. Field of the Invention

The present invention relates to a housing arrangement for a friction clutch and to a method for producing the housing arrangement.

2. Description of the Related Art

In friction clutches used in the motor racing sector, a housing arrangement is provided in which a ring-like housing wall region has on its inside a toothing formation with which lamellae or friction members designed in the manner of a friction disk are in rotary take-up engagement. One axial end face of this ring-like housing wall region is connected to a housing bottom region which is shaped like an annular disk and which forms, for example, a flywheel. The two components, i.e., the housing wall region and the annular disk-shaped housing bottom region, are produced separately. For example, the housing wall region together with the toothing formation provided on its inside is produced by wire erosion from a ring-like blank, that is to say a blank provided with essentially unstructured surfaces on its inside. The housing bottom region is also produced separately as a ring-like disk component and is subsequently firmly connected to the housing wall region by welding such as, for example, electron-beam welding. The subassembly produced in this way has to be reworked in order to obtain the necessary precision, for example by the weld seam being lathe-turned. In addition to the complexity of carrying out this operation of producing such a component, the operation to connect two components by welding to obtain the subassembly with high precision always entails a risk that the heat introduced by the connecting operation may introduce nonuniformities. While such nonuniformities may appear to be insignificant, at least some of these seemingly insignificant nonuniformities may lead to considerable unbalanced oscillations, particularly as rotational speeds of up to 18000 revolutions per minute are often reached in motor racing.

### SUMMARY OF THE INVENTION

The object of the present invention is to provide a housing arrangement for a friction clutch, which can be produced in a simple way and without the risk of non-uniformities being incorporated therein. The invention relates, furthermore, to a method for producing a housing arrangement of this type.

The object of the present invention is met by a housing arrangement for a friction clutch which includes a ring-like housing wall region which has on its radially inward-facing inside a toothing formation for the rotary coupling of at least one friction member and an annular disk-shaped housing bottom region integral with the housing wall region.

By the housing arrangement being configured integrally with the housing wall region and with the housing bottom region, there is no need for these two regions of the housing arrangement to be connected to one another by subsequent machining operations and for any remachining or correcting measures to be carried out thereafter. The connecting operation, which is critical with regard to the generation of nonuniformities in the prior art, may therefore be dispensed with.

The toothing formation may, for example, have a plurality of toothing projections extending in the direction of a housing longitudinal axis and succeeding one another in the circumferential direction.

So that, on the one hand, the manufacture of the toothing formation on the housing wall region can be facilitated and, on the other hand, a weight saving may also be obtained at the same time, at least one orifice may be adapted at least partially to the shape of the toothing projections in the housing bottom region. Each of these orifices is arranged in a region lying between two toothing projections.

The object of the present invention is also achieved by a method for producing a housing arrangement for a friction clutch according to the invention, the method including the steps of producing a housing blank with a ring-like housing wall region and with a housing bottom region formed as a single integral unit with the latter. The method further includes forming a toothing formation on an inner side of the ring-like housing wall region. According to the present invention, therefore, the toothing formation is formed only when a housing blank comprising the housing wall region and the housing bottom region is finished essentially in its basic shape.

In the step of producing, the ring-like housing wall region may be provided with an essentially unstructured surface on its inside. It is thus possible, for example, either to produce the housing blank in a casting operation and then give it its basic shape by lathe turning or to work said housing blank out of a solid material block, for example, again, by lathe turning.

So that as little material as possible has to be machined during the subsequent manufacture of the toothing formation, it is proposed that the step of producing includes providing the ring-like housing wall region with an inside diameter which corresponds essentially to the minimum inside diameter of the toothing formation to be formed.

The measures for producing the toothing formation may also comprise material-removing machining steps. The toothing formation may, for example, be formed by wire erosion. In order to make this wire erosion possible in the case of the housing blank which has an essentially bowl-like design and is to be provided according to the present invention, it is proposed that an orifice for leading through an eroding wire be formed in the housing bottom region in a region between two toothing projections of the toothing formation which are to be formed.

In the motor racing sector, above all, there is an essential requirement to provide the various components with as low a weight as possible. In addition to the selection of suitable materials which have a correspondingly low density and can also ensure the necessary stability, at least one radial orifice lying between two toothing projections may be formed in the housing wall region before or after the step of forming a toothing formation.

So that the housing arrangement according to the present invention may be connected in a simple way to a housing cover, on which, for example, a force accumulator may then also be supported, an axial orifice, preferably an internally threaded orifice, may be formed on an end face of the housing wall region which is remote from the housing bottom region, in the region of at least one toothing projection or in the region of toothing projection still to be formed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a perspective view of an axial side of a housing arrangement according to the present invention;

FIG. 2 is a perspective view of the other axial side of the housing arrangement shown in FIG. 1;

FIG. 3 is an axial view of the axial side of the housing arrangement shown in FIG. 1;

FIG. 4 is an enlarged detailed view of a portion of the housing arrangement contained in the circle IV in FIG. 3;

FIG. 5 is a longitudinal sectional view of the housing arrangement along line V-V in FIG. 3.

### DETAILED DESCRIPTION OF THE PRESENTLY PREFERRED EMBODIMENTS

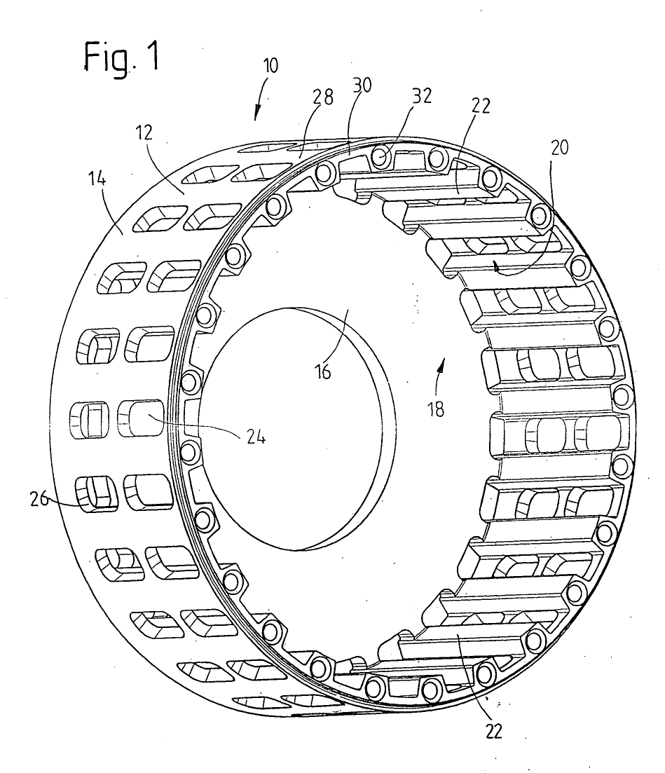

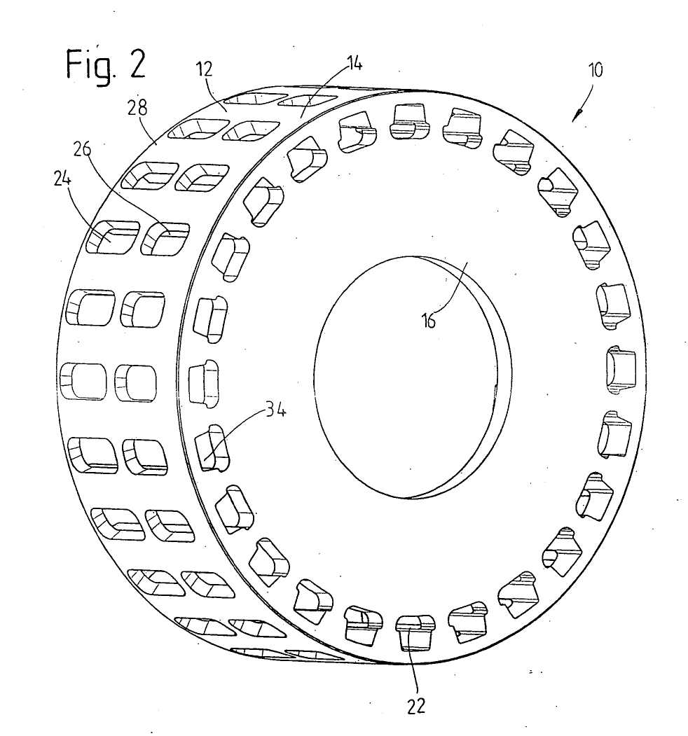

A housing arrangement 10 according to the present invention for a friction clutch is shown FIGS. 1 and 2. The housing arrangement 10 comprises a ring-like housing wall region 12 having an axial end region 14 connected integrally to a housing bottom region 16 which is shaped as an annular disk. That is, the housing wall region 12 and the housing bottom region 16 are formed from a single material block, i.e., the housing wall region 12 is formed integrally with the housing bottom region 16. Accordingly, the housing wall region 12 and the housing bottom region 16 are not separate or discrete components assembled into a unit by any subsequent connecting or joining operations.

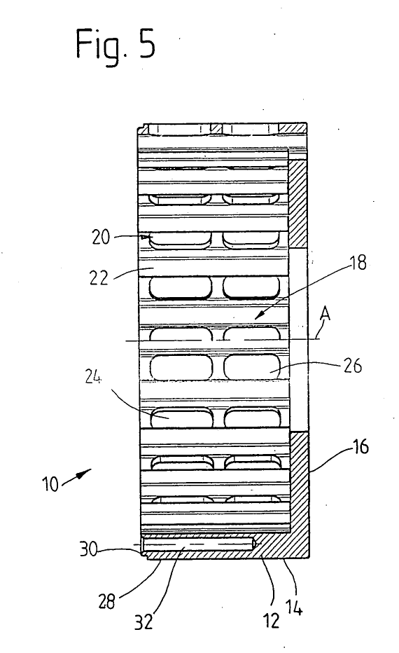

FIG. 1 shows that the radially inner side 18 of the ring-like housing wall region 12 is structured and has a toothing formation 20 which includes toothing projections 22 extending essentially over the entire axial length of the housing wall region 12. Corresponding countertoothing projections of friction members are receiveable in engagement with these toothing projections 22 so that the friction members are fixed with respect to rotation relative to the housing arrangement 10 and still movable axially with respect to the housing arrangement 10. Two axially successive radial orifices 24, 26 are provided in the housing wall region 12 between each adjacent pair of toothing projections 22 of the toothing formation 20 (see also FIG. 5). These radial orifices 24, 26 ensure through ventilation and therefore better cooling of the friction clutch comprising the housing arrangement 10 and also contribute to weight saving. Furthermore, axial orifices 32 are provided in the toothing projections 22 of the toothing formation 20, the axial orifices 32 preferably being designed as internally threaded orifices. The axial orifices are provided on an end face 30 provided in a second end region 28 of the housing wall region 12 (see FIG. 5). These orifices 32 may receive screw bolts for securing a housing cover to the axial end region 28 of the housing wall region 12. A force accumulator acting upon the various friction members of the friction clutch which includes the housing arrangement 10 may be supported on this housing cover which is not illustrated in the figures. Of course, the housing bottom region 14 may also form the portion serving as the force support and a cover still to be connected to the housing wall region 12 may then take effect as a flywheel and the tie-up to a drive assembly may be provided.

FIG. 2 shows that a plurality of orifices 34 are formed in the housing bottom region 16 which succeed one another in a circumferential direction and are positioned with respect to the circumferential successive toothing projections 22 such that the orifices lie essentially in each case centrally between two such toothing projections 22. As shown in FIG. 4, these orifices 34 correspond in regions, in their circumferential contour, to the circumferential contour of the toothing projections 22. The contour of the orifices especially corresponds to the toothing flanks 36, 38 located in the circumferential direction and to the transitional region to the radially inner surface 40 of the various toothing projections 22. This radially inner surface 40 of each toothing 22 is shaped as a segment of an annulus, such that all the radially inner surfaces 40 of the toothing projections 22 span an annular area represented by a line R in FIG. 4.

A procedure for producing the housing arrangement 10 described above in terms of its structural set-up is described below.

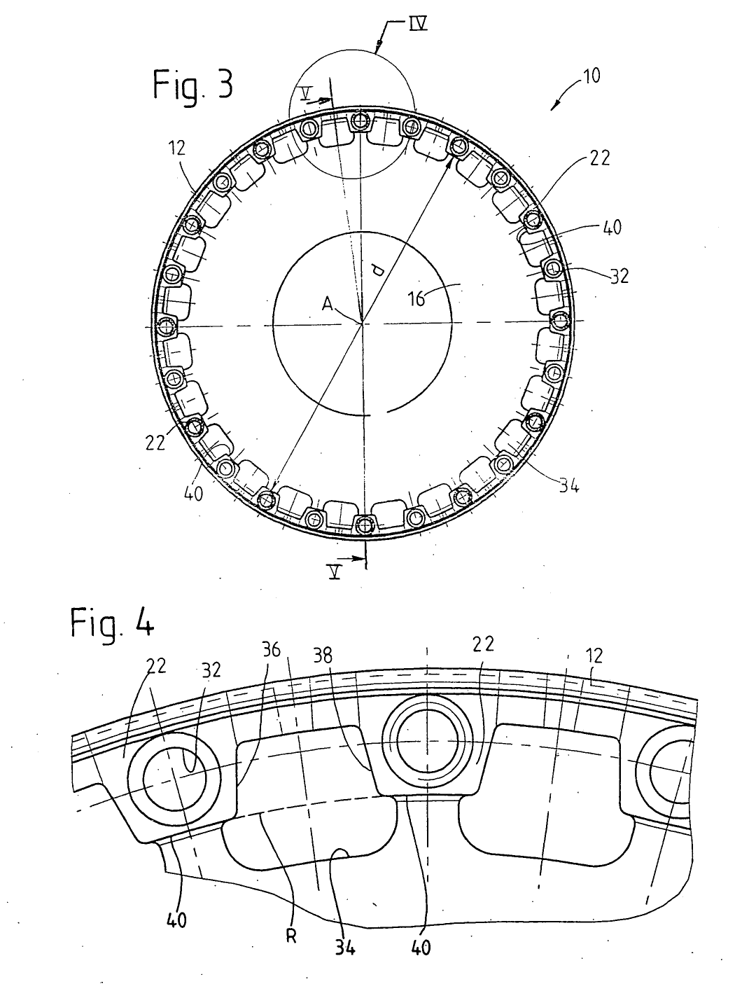

In a first production phase, a housing blank is generated, which has an essentially bowl-like configuration and already possesses the housing bottom region 16 and a ring-like housing wall region 12, but without structuring on the radially inner side 18. This housing blank may be produced, for example, by the turning-out of a metal material block, for example steel material, aluminum material or other metal material. In principle, a blank with this basic shape may even be provided in a casting method, in which case this blank then has to be reworked again by lathe turning or the like to obtain the necessary precision. In this operation, the initially still unstructured housing wall region 12 is provided with an inside diameter d (see FIG. 3) which corresponds essentially to the distance between the radially inner surfaces 40 of two toothing projections located opposite one another with respect to the housing longitudinal axis A in the finished housing arrangement 10.

In the next operation, orifices are then formed, for example by drilling, in those regions in which the orifices 34 are subsequently to be found in the housing bottom region 16. That is, these orifices in the region of orifices 34 are made in a circumferential region which lies between two toothing projections 22 of the toothing formation 20 which are still to be formed. An eroding wire is then drawn through these orifices. The eroding wire is used to cut out from the housing wall region 12 the material regions lying between each adjacent pair of toothing projections 22 directly succeeding one another in the circumferential direction.

During the previous production steps of producing the housing blank care was already taken to ensure that the inner dimension of the ring-like housing wall region 12 corresponds to the mutual distance between the radially inner surfaces 40 of two toothing projections 22 located opposite one another. Accordingly, the toothing flanks 36, 38 are being produced during the eroding operation. Cutting must take place radially inward only to an extent such that the circle-like junction to the inner surfaces 40 already present is obtained. This results, therefore, in the mushroom-shaped configuration, as shown in FIG. 4, of the orifices 34 then generated in the housing bottom region 16 during this eroding operation.

When the individual toothing projections 22 of the toothing formation 20 have then been formed, the radial orifices 24, 26 already referred to above may be formed in each case in the region between two toothing projections 22. In principle, the formation of radial orifices could also be carried out before the toothing formation 20 is formed. Further, the orifices 32 are then generated in the region of the toothing projections 22 on the end face 30. The formation of orifices 32 could also be performed before the toothing projections 22 are worked out.

According to the inventive method, a housing arrangement is then provided on which no further substantial machining operations are to be carried out. The surfaces formed by material-removing machining could, in principle, also be smoothed out. The housing arrangement 10 thus provided may then, of course, also be subjected to a balancing operation.

The present invention allows a housing arrangement for a friction clutch to be provided in a simple way, but nevertheless with very high precision, which can be exposed to even very high loads such as those experienced in motor racing. Since the entire component is formed from a material block, a very high stability is obtained, and there is basically no risk that non-uniform formations will be produced during production as a result of the assembly of various components.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A housing arrangement for a friction clutch, comprising a ring-like housing wall region having a longitudinal axis and a radially inward-facing inner side, a toothing formation arranged on said inner side for the rotary coupling of at least one friction member, and an annular disk-shaped housing bottom region on one axial side of said housing wall region, wherein said housing bottom region is formed integrally with said housing wall region.

2. The housing arrangement for a friction clutch of claim 1, wherein said toothing formation has a plurality of toothing projections extending in the direction of the longitudinal axis and succeeding one another in a circumferential direction.

3. The housing arrangement for a friction clutch of claim 2, wherein said housing bottom region defines an orifice extending axially therethrough and adapted at least partially to the shape of the toothing projections between each adjacent pair of toothing projections.

4. A method for producing a housing arrangement for a friction clutch, comprising the steps of:
producing a housing blank with a ring-like housing wall region and an annular disk-shaped housing bottom region such that the housing bottom region is formed integrally with the housing wall region; and
forming a toothing formation on a radially inner side of the ring-like housing wall region, the toothing formation arranged for engaging at least one friction member of the friction clutch.

5. The method of claim 4, wherein said step of producing comprises providing the ring-like housing wall region with an essentially unstructured surface on the radially inner side thereof.

6. The method of claim 4, wherein said step of producing comprises providing the ring-like housing wall region with an inside diameter which corresponds essentially to the minimum inside diameter of the toothing formation to be formed during said step of forming.

7. The method of claim 4, wherein said steps of producing the housing blank and forming the toothing formation each comprise using a material-removing machining operation.

8. The method of claim 4, wherein said step of forming comprises forming the toothing formation using wire erosion.

9. The method of claim 8, wherein said step of forming comprises forming an orifice in the housing bottom region for leading through an eroding wire therethrough in a region between two toothing projections of the toothing formation which are to be formed.

10. The method of claim 4, further comprising the step of forming at least one radial orifice in the housing wall region lying between two toothing projections.

11. The method of claim 10, wherein said step of forming at least one radial orifice is performed before the step of forming the toothing formation.

12. The method of claim 10, wherein said step of forming at least one radial orifice is performed after the step of forming the toothing formation.

13. The method of claim 4, further comprising the step of forming an axial orifice on an end face of the housing wall region which is remote from the housing bottom region and in a region of at least one toothing projection.

14. The method of claim 13, wherein the axial orifice is an internally threaded orifice.

15. The method of claim 13, wherein said step of forming an axial orifice is performed before the step of forming the toothing formation.

16. The method of claim 13, wherein said step of forming an axial orifice is performed after the step of forming the toothing formation.
